(19) United States
(12) Patent Application Publication
(10) Pub. No.: US 2018/0260381 A1
(43) Pub. Date: Sep. 13, 2018

(54) PREPOSITIONAL PHRASE ATTACHMENT OVER WORD EMBEDDING PRODUCTS

(71) Applicant: Xerox Corporation, Norwalk, CT (US)

(72) Inventors: Xavier Carreras, Saint Ismier (FR); Ariadna Julieta Quattoni, Saint Ismier (FR)

(73) Assignee: Xerox Corporation, Norwalk, CT (US)

(21) Appl. No.: 15/454,296

(22) Filed: Mar. 9, 2017

(51) Int. Cl. G06F 17/27

(52) U.S. Cl. CPC G06F 17/274; G06F 17/271; G06F 17/2785

(57) ABSTRACT

A method for resolving prepositional phrase attachments includes, for an input sequence of text, identifying a prepositional phrase and a set of candidate heads for the prepositional phrase. The prepositional phrase includes a preposition and a modifier. For each candidate head in the set of candidate heads, the candidate head is scored with a scoring function which outputs a score as a function of a tensor product of a word embedding of the candidate head, a product of word embeddings of the preposition and modifier of the preposition, and a matrix of learned parameters or a decomposition thereof. One of the candidate heads is identified as a predicted head for attachment to the prepositional phrase based on the scores for the candidate heads.

### BACKGROUND

The exemplary embodiment relates to natural language processing and finds particular application in an automated method for resolving Prepositional Phrase (PP) attachment.

Syntactic parsing is widely used in a variety of Natural Language Processing (NLP) applications, especially in information extraction systems when the goal is to mine relations and events from unstructured data. Such parsing systems rely on the availability of lexical information, which is obtained from the training data of the parser. However, when text in a different domain from that used for training the parser is to be processed with the trained parser, new words that have not been observed in the training lack the lexical information for effective syntactic parsing. This can result in a significant drop in accuracy. Systems used for processing text in business-relevant domains that differ significantly from the “training” domains of the NLP components often suffer from this problem, since the training data used may include newswire or other public documents, while the target domain could be related to healthcare, social media, or the like.

One problem commonly faced in syntactic parsing is in identifying prepositional phrase (PP) attachment. A prepositional phase, as used herein, is a syntactic construct which is/includes a preposition followed by a modifier of the preposition. The modifier of the preposition is a noun phrase, which includes a noun or pronoun serving as the object of the preposition, and any modifiers of that object. PP attachment involves determining the textual element (e.g., a verb or noun) participating in a syntactic dependency with a prepositional phrase, which is referred to as a head. In English, the head precedes the prepositional phrase, but may not in other languages. Identifying PP attachment is one of the main sources of errors of syntactic parsers in part because solving PP attachment cases depends on characterizing syntactico-semantic properties of the words involved in the attachment decision. Jonathan K. Kummerfeld, et al., “Parser showdown at the Wall Street corral: An empirical investigation of error types in parser output,” Proc. 2012 Joint Conf. on Empirical Methods in Natural Language Processing and Computational Natural Language Learning, pp. 1048-1059, 2012.

Consider the examples in FIG. 1. In both cases, the prepositional phrase is preceded by both a verb and a noun and thus could potentially be attached to either of them. For the first case, the correct attachment for the prepositional phrase by_Hudson (the determiner the can be ignored) is to the noun, restaurant, rather than the verb went. In the second case, the attachment site of the prepositional phase by bike is the verb went. While the attachments are ambiguous, the ambiguity is more severe when unseen or infrequent words like Hudson are encountered.

Existing approaches for resolving PP attachment employ a wide range of lexical, syntactic, and semantic features and may make use of knowledge resources, such as WordNet and VerbNet. See, for example, Stetina, et al., “Corpus based PP attachment ambiguity resolution with a semantic dictionary,” Proc. 5th Workshop on Very Large Corpora, pp. 66-80, 1997 (hereinafter, Stetina 1997); Agirre, et al., “Improving parsing and PP attachment performance with sense information,” ACL, pp. 317-325, 2008; Zhao, et al., “A nearest-neighbor method for resolving PP-attachment ambiguity,” Natural Language Processing—IJCNLP, pp. 545-554, 2004, hereinafter, Zhao 2004; Hindle, et al., “Structural ambiguity and lexical relations,” Computational linguistics, 19(1):103-120, 1993; Collins, et al., “Prepositional phrase attachment through a backed-off model,” Natural Language Processing Using Very Large Corpora, pp. 177-189, 1999; Ratnaparkhi, et al., “A maximum entropy model for prepositional phrase attachment,” Proc. Workshop on Human Language Technology, pp. 250-255, 1994, hereinafter, “Ratnaparkhi 1994”; Olteanu, et al., “PP-attachment disambiguation using large context,” Proc. HLT and EMNLP, pp. 273-280, 2005. Recently, word embeddings have been used as representations for lexical items. See, Mikolov, et al., “Efficient estimation of word representations in vector space,” Int'l Conf. on Learning Representations, 2013, hereinafter, “Mikolov 2013”; Pennington, et al., “Glove: Global vectors for word representation,” Empirical Methods in Natural Language Processing (EMNLP), pp. 1532-1543, 2014. Recent work in dependency parsing suggests that these embeddings can also be useful to resolve PP attachment ambiguities. Chen, et al., “A fast and accurate dependency parser using neural networks,” Proc. 2014 Conf. on Empirical Methods in Natural Language Processing (EMNLP), pp. 740-750, 2014; Lei, et al., “Low-rank tensors for scoring dependency structures,” Proc. 52nd Annual Meeting of the ACL (Vol. 1: Long Papers), pp. 1381-1391, 2014, hereinafter, “Lei 2014.”

The principle behind these approaches is that the dimensions of a word embedding capture lexical, syntactic, and semantic features of words, in essence, the type of information that is exploited in PP attachment systems. One approach employs neural networks that compose the embeddings of the words in the PP attachment structure. Belinkov, et al., “Exploring compositional architectures and word vector representations for prepositional phrase attachment,” Trans. ACL, 2:561-572, 2014, hereinafter, “Belinkov 2014,” The model of Belinkov composes word embeddings by first concatenating vectors and then projecting to a low-dimensional vector using a non-linear hidden layer. This basic composition block is used to define several compositional models for PP attachment. However, projecting concatenated embeddings can result in hidden disjunctions of the input coefficients.

Tensor models have also been investigated for PP attachment. These focus on tensor-based feature engineering of standard feature templates that combine different sources of information, such as PoS tags, lexical information, positional information, etc. See, Yu, et al., “Embedding lexical features via low-rank tensors,” Proc. 2016 Conf. of the North American Chapter of the ACL: Human Language Technologies, pp. 1019-1029, 2016 hereinafter, “Yu 2016” One advantage of the tensor representation is that it allows controlling the model capacity using low-rank constraints. Low-rank tensor learning has been performed by either directly optimizing over a low-rank decomposition of the tensor, such as a Tucker form (Lei 2014; Yu 2016) or by unfolding the tensor into a matrix, and applying singular value decomposition (SVD) to obtain a low-rank approximation.

### INCORPORATION BY REFERENCE

The following reference, the disclosure of which is incorporated by reference in its entirety, is mentioned:

U.S. application Ser. No. 15/171,393, filed Jun. 2, 2016, entitled SCALABLE SPECTRAL MODELING OF SPARSE SEQUENCE FUNCTIONS VIA A BEST MATCHING ALGORITHM, by Ariadna Quattoni, et al.

### BRIEF DESCRIPTION

In accordance with one aspect of the exemplary embodiment, a method is provided for resolving prepositional phrase attachments. The method includes for an input sequence of text, identifying a prepositional phrase and a set of candidate heads for the prepositional phrase, the prepositional phrase comprising a preposition and a modifier. For each candidate head in the set of candidate heads, the method includes scoring the candidate head with a scoring function which outputs a score as a function of a tensor product of: a) a word embedding of the candidate head, b) a product of word embeddings of the preposition and modifier of the preposition, and c) a matrix of learned parameters or a decomposition thereof. One of the candidate heads is identified as a predicted head for attachment to the prepositional phrase, based on the scores for the candidate heads.

One or more of the steps of the method may be performed with a processor.

In accordance with another aspect of the exemplary embodiment, a system for resolving prepositional phrase attachments includes memory which stores a matrix of learned parameters or a decomposition of the matrix into lower-rank matrices. For an input sequence of text, a parser identifies a prepositional phrase and a set of candidate heads for the prepositional phrase, the prepositional phrase including a preposition and a modifier. An embedding component identifies embeddings for the candidate heads, the preposition and the modifier. A prediction component identifies one of the candidate heads for attachment to the prepositional phrase. The prediction component uses a scoring function which, for each candidate head in the set of candidate heads, outputs a score as a function of a tensor product of: a) a word embedding of the candidate head, b) a product of word embeddings of the preposition and modifier of the preposition, and c) a matrix of learned parameters. An output component outputs the identified one of the candidate heads or information based thereon. A processor implements the parser, embedding component, prediction component and output component.

In accordance with another aspect of the exemplary embodiment, a method for resolving prepositional phrase attachments includes receiving a training set of tuples. Each tuple consists of a preposition, a modifier of the preposition, a list of candidate heads, and a pointer to one of the candidate heads that is a correct one. A word embedding is identified for each of the heads, prepositions, and modifiers in the training set. A matrix of parameters is learned using the word embeddings of the tuples. A parser is provided which is configured for identifying a prepositional phrase and a set of candidate heads for the prepositional phrase for an input sequence of text, the prepositional phrase comprising a preposition and a modifier. A prediction component configured to identify one of the candidate heads for attachment to the prepositional phrase is provided. The prediction component uses a scoring function which, for each candidate head in the set of candidate heads, outputs a score as a function of a tensor product of a) a word embedding of the candidate head, b) a product of word embeddings of the preposition and modifier of the preposition, and c) the matrix of learned parameters.

### BRIEF DESCRIPTION OF THE DRAWINGS

FIG. 1 illustrates examples of prepositional phrase attachment problems;

FIG. 2 is a functional block diagram of a natural language processing system in accordance with one aspect of the exemplary embodiment;

FIG. 3 is a flowchart illustrating a method for prepositional phrase attachment in accordance with one aspect of the exemplary embodiment;

FIG. 4 illustrates unfolding of a tensor product of word embeddings; and

FIG. 5 is a plot illustrating accuracy versus rank using the nuclear norm (l*) for computing prepositional phrase attachments.

### DETAILED DESCRIPTION

A system and method are described which use word embeddings (multidimensional vectors) for predicting prepositional phrase attachment.

The word embeddings of a head, preposition, and modifier for each of a set of PP attachment structures are composed as a three dimensional tensor, which can be decomposed to generate a model comprising a matrix. The capacity of the model is constrained by imposing low-rank constraints on the corresponding tensor which can be formulated as a convex loss minimization.

Experiments on several datasets and settings demonstrate that this multilinear model can give performances comparable to or better than more complex neural network models that use the same basic information.

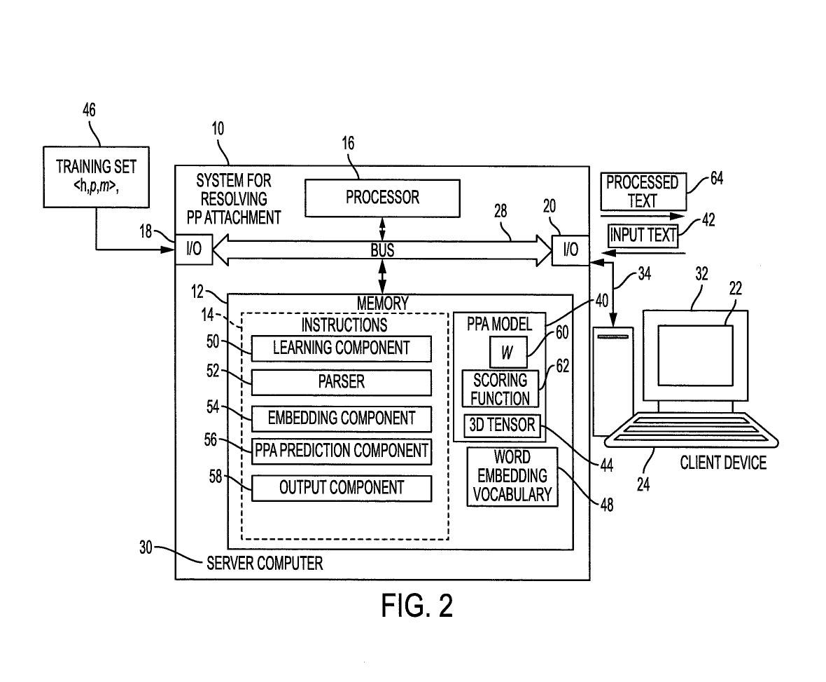

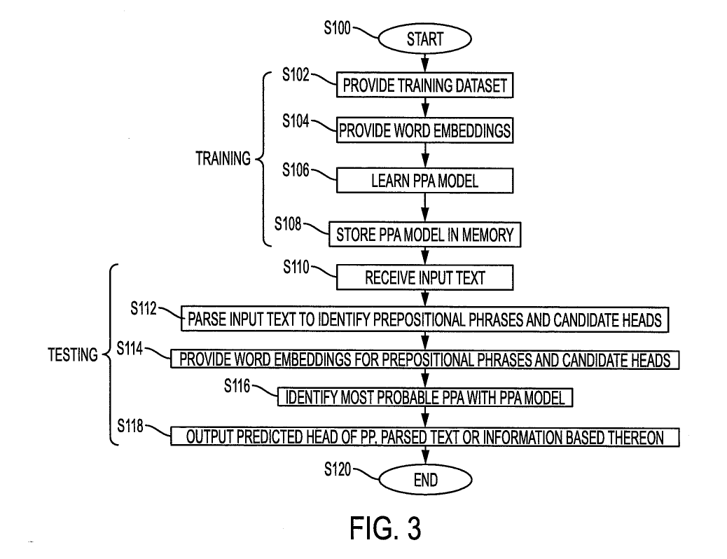

With reference to FIG. 2, a functional block diagram of a system 10 for natural language processing (NLP) which predicts prepositional phrase attachments is shown. The illustrated system 10 includes memory 12, which stores software instructions 14 for performing the method illustrated in FIG. 3, and a processor 16, in communication with the memory, for executing the instructions. The system 10 also includes one or more input/output (I/O) devices, such as a network interface 18 and a user input output interface 20. The I/O interface 20 may communicate with one or more of a display device 22, for displaying information to users, speakers, and a user input device 24, such as a keyboard or touch or writable screen, and/or a cursor control device, such as mouse, trackball, or the like, for inputting text and for communicating user input information and command selections to the processor device 16. The various hardware components 12, 16, 18, 20 of the system 10 may all be communicatively connected by a data/control bus 28.

The computer system 10 may include one or more computing devices 30, such as a PC, such as a desktop, a laptop, palmtop computer, portable digital assistant (PDA), server computer, cellular telephone, tablet computer, pager, combination thereof, or other computing device capable of executing instructions for performing the exemplary method. The display device 22 and user input device 24 may be linked to the computer 30, or be part of a separate computing device 32, that is wired or wirelessly linked to the computer input 20 via a link 34, local area network or a wired area network, such as the internet or a wireless phone network.

The system 10 employs a model 40 (PPA model) for use in predicting prepositional phrase attachments in input natural language text 42. The model 40 may be stored in memory 12, or may be accessed from a separate memory storage device. The exemplary model 40 is the unfolding of a 3-D tensor 44 that is generated from a training set 46 of correct prepositional phrase attachments, which may be extracted from text strings, such as sentences, which may be drawn from a domain of interest. A vocabulary 48 stores word embeddings for a set of words. Each word embedding is a mapping from a word to a multidimensional vector of the same number of dimensions. In general, no two words share the same word embedding.

The memory 12 may represent any type of non-transitory computer readable medium such as random access memory (RAM), read only memory (ROM), magnetic disk or tape, optical disk, flash memory, or holographic memory. In one embodiment, the memory 12 comprises a combination of random access memory and read only memory. In some embodiments, the processor 16 and memory 12 may be combined in a single chip. Memory 12 stores processed data and instructions for running the computer as well as the instructions for performing the exemplary method.

The network interface 18, 20 allows the computer to communicate with other devices via a computer network, such as a local area network (LAN) or wide area network (WAN), or the internet, and may comprise a modulator/demodulator (MODEM) a router, a cable, and/or Ethernet port.

The digital processor device 16 can be variously embodied, such as by a single-core processor, a dual-core processor (or more generally by a multiple-core processor), a digital processor and cooperating math coprocessor, a digital controller, or the like. The digital processor 16, in addition to executing instructions 14 may also control the operation of the computer 30.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The illustrated instructions 14 include a set of components, e.g., software, including a model learning component 50, a parser 52, an embedding component 54, a prepositional phrase attachment (PPA) prediction component 56, and an output component 58.

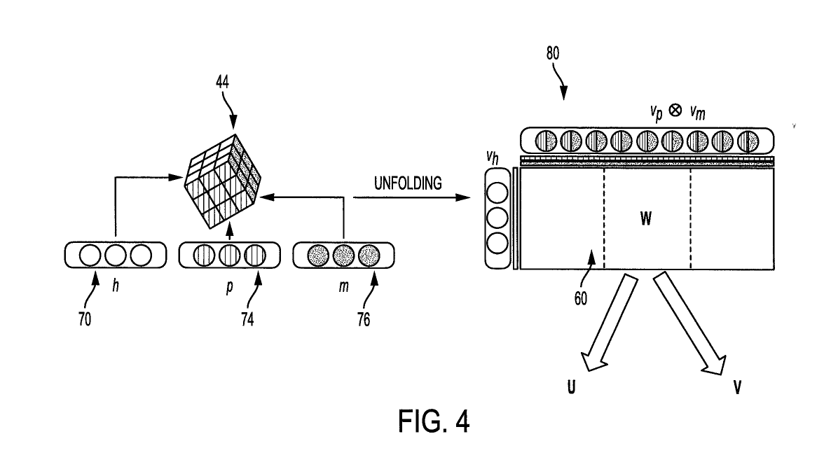

Briefly, the model learning component 50 learns the PPA model 40, using prepositional phrases and respective heads in the training set 46, which compose a 3D tensor 44. In particular, the model learning component 50 learns a parameter matrix 60, as the unfolding of the 3D tensor (FIG. 4), which is subsequently employed in a scoring function 62 to predict PPAs in the input text 42.

The parser 52 is configured for processing an input text sequence 42, such as a sentence, in the same natural language as used for generation of the training dataset 46, to identify a prepositional phrase and a candidate set of heads.

The embedding component 54 retrieves, from the vocabulary 48, the word embeddings of the preposition and modifier of the identified prepositional phrase and each of the heads in the candidate set of heads.

The prepositional phrase attachment (PPA) prediction component 56 predicts which of the candidate set of heads is the most probable for attachment to the prepositional phrase using the learned model 40. In particular, as described in greater detail below with reference to FIG. 4, for each of the candidate heads, the scoring function 62 is computed of the word embedding of the candidate head, an embedding of the prepositional phrase, and the matrix 60 of parameters, wherein the embedding of the prepositional phrase is computed as a product of the word embeddings of the preposition and modifier of the prepositional phrase. The product computed may be an outer product, such as the Kronecker product. The exemplary function is a product of the word embedding of the candidate head, matrix and prepositional phrase embedding, which generates a scalar value. The candidate head from the set of candidate heads which yields the optimal (e.g., highest) value of the function is output as the predicted head of the prepositional phrase.

As will be appreciated, a given input text sequence may include more than one prepositional phrase, in which case, the PPA prediction component 56 may predict a respective head for each. Additionally, if only one candidate head is found for a prepositional phrase, there is no need to predict an attachment head.

In some embodiments, the prepositional phrase attachment information may be may be used to tag the input text with a tag linking the identified head to the respective prepositional phrase. In some embodiments, the prepositional phrase attachment information may be used by other rules of the parser 52 to generate further information.

The output component 58 outputs the head predicted by the model 40, or other information based thereon, such as processed input text 64 incorporating tags, such as HTML tags, or the like, which identify prepositional phrase attachments.

In some embodiments, the model learning component 50 may be part of a separate computer system, since it is not needed once the model 40 has been learned.

With reference now to FIG. 3, a method for learning and using a PPA model 40 is illustrated. The method may be implemented with the computer system shown in FIG. 2. The method begins at S100.

At S102, a training set 46 of ground truth prepositional phrase attachments is provided. These may include a collection of tuples, each tuple including a set of at least one head, a preposition and its modifier extracted from a same sentence. The correct head in the set of heads is labeled as a positive example and all other heads, where present, are negative samples.

At S104, word embeddings are provided for a collection of words, including words that occur in the training set 46. In some embodiments, this includes generating the word embeddings. In some embodiments, previously-generated word embeddings are obtained. The word embeddings may be retrieved from vocabulary 48.

At S106, the prepositional phrase model 40 is learned. As described below with respect to FIG. 4, this may include leaning a matrix 60 which optimizes a loss function over the training set 46, in which tuples in the training set 46 are represented by their respective word embeddings.

At S108, the learned PPA model 40, including the learned matrix 60 and scoring function 62, is stored in memory 12. This ends the training phase.

At S110, input text 42 in the natural language is received by the system input 20, e.g., from the client device 24, and may be stored in memory 12 during processing.

At S112, each sentence of the input text is processed by the parser 52 to identify prepositional phrases and, for each identified prepositional phrases, a respective set of candidate heads is identified for possible attachment.

At S114, for each preposition and each modifier in each prepositional phrase, a respective word embedding may be retrieved from the vocabulary 48. In other embodiments, at least some prepositional phrase representations may have been precomputed and stored, e.g., in vocabulary 48. Each precomputed prepositional phrase may be an outer product of the word embeddings of the respective preposition and modifier. A word embedding for each of the candidate heads is also identified from the vocabulary 48.

At S116, for each prepositional phrase identified in a text string, a score for each of the candidate heads is computed, using the scoring function 62 that includes the learned matrix 60. Based on the scores, a most probable one of the candidate heads is identified for attachment to the identified prepositional phrase. The input text may be tagged or otherwise associated with information which identifies the prepositional phrase attachment.

At S118, information 64 is output, such as the identified PPAs in the input text 42, or other information based thereon.

The method ends at S120.

The method illustrated in FIG. 3 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 3, can be used to implement all or a part of the method. As will be appreciated, while the steps of the method may all be computer implemented, in some embodiments one or more of the steps may be at least partially performed manually.

Further details of the system and method will now be described.

### Training Set Generation (S102)

The training set may be generated manually or partially manually. For example, the parser 52 may be used to process text sentences in a domain of interest to identify prepositional phrases and candidate heads. A user may review the processed text sequences and tag the correct head for each identified prepositional phrase. The system may then collect these tagged examples into a training set 46 of tuples, each tuple including a preposition, a modifier of the preposition, and a set of heads, only one head tagged as correct, the rest by default, being incorrect.

### Word Embeddinqs (S104 and S114)

For any word w in the vocabulary 48, the word embedding of w is an n-dimensional vector, which is denoted by vₓ∈Rⁿ, where R represents the set of real numbers and n may be for example, at least 20, or at least 50, or up to 1000, or up to 500. Any suitable type of word embedding may be employed, where semantically similar words are mapped to nearby points. This is achieved by incorporating contextual information from surrounding words in a training corpus of text sentences, so that words found in similar contexts have similar embeddings.

For unknown words, i.e., words that do not appear in the vocabulary 48, a default word embedding may be used. This can be an average of embeddings for a set of the least-frequently observed words in the training corpus.

A fixed dimension set to 1 to may be added to all word vectors. This extra dimension has the effect of keeping all lower-order conjunctions when a product of embeddings is later computed, including each elementary coefficient of the word embeddings and a bias term.

As an example of suitable types of word embedding, one of the following may be employed:

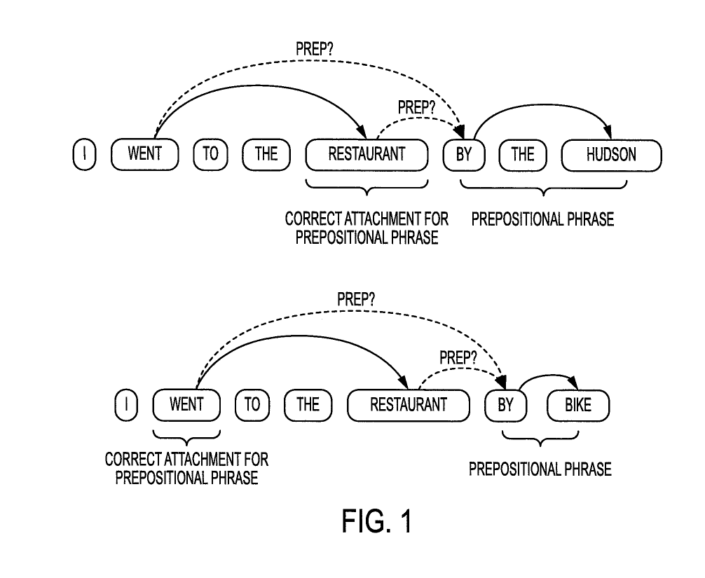

1. Word2vec. This predictive model has two types: the Skip-Gram model and the Continuous Bag-of-Words model (CBOW). These models are similar, except that CBOW predicts target words (e.g. ‘mat’) from source context words (‘the cat sits on the’), while the skip-gram does the inverse and predicts source context-words from the target words. See, Mikolov 2013, for a description of these models. In the Skip-Gram model, the “context” of a given word is defined by a window of a selected size which defines the number of preceding and/or following words. As an example, in the first sentence of FIG. 1, I went to the restaurant by the Hudson, if the window is of size 3 preceding words, the context for the word restaurant is went to the.

The appropriate size of the window may be selected, experimentally, to give the optimal performance and may be, for example, from 2-10, such as at least 3, or at least 4. With a larger context window, words that are topically-related tend to get closer, while with a small window size, close words tend to share the same POS tag, which is less relevant for PP attachment because the position in the attachment structure already indicates the POS tag.

2. Skip-dep: This is similar to a Skip-gram model, but uses dependency trees to define the context words during training. Thus, it captures syntactic correlations. See, Bansal, et al., “Tailoring continuous word representations for dependency parsing,” Proc. ACL, pp. 809-815, 2014, hereinafter, “Bansal 2014,” for further details on this method.

3. Neural Network-based embeddings: these may employ recurrent neural networks, as described, for example, in Bengio, et al., “A neural probabilistic language model,” NIPS (2001).

In general, such methods rely on large amounts of training data, such as a training corpus of millions of text sequences, for generating the word embeddings. Accordingly, a pre-generated vocabulary 60 generated on an out-of-domain corpus may be used, rather than training data 46.

In the exemplary embodiment, the word embeddings are used as the only source of lexical information for the PPA decision. However, it is also contemplated that other features may also play a part in the attachment decision. For example, the word embeddings could be increased in dimensionality to add additional features. For example some of these added dimensions may be used to encode positional information, as in the method of Belinkov 2014.

### PP Attachment

By way of introduction, two existing approaches will first be described.

Ratnaparkhi 1994 suggests formulation of PP attachment as a binary prediction problem: given a four-way tuple [symbol] v,o,p,m [symbol] where v is a verb, o is a noun object, p is a preposition, and m is a modifier noun, the aim is to decide whether the prepositional phrase p-m attaches to the verb v or to the noun object o.

Belinkov 2014 proposed a generalization of PP attachment that considers multiple attachment candidates: given a tuple [symbol] H,p,m [symbol] , where H is a set of candidate attachment tokens, the aim is to decide what is the correct attachment for the p-m prepositional phrase. The binary case corresponds to H={v, o}. This generalized setting directly captures the PP attachment problem in the context of dependency parsing, where multiple attachment candidates are considered (e.g., all verbs and nouns of a sentence).

In the present method, the generalized definition is used. Given a tuple [symbol] H,p,m [symbol] , the model 40 computes the following prediction:

$$arg {max}_{h ∈ H} f ( h , p , m ) \qquad ( 1 )$$

where ƒ is a function that scores a candidate attachment h or “head” for the p-m phrase, where p is a preposition and h is a modifier (e.g., a noun), that is in a syntactic dependency with the preposition p. A suitable definition of ƒ, based on tensor products of word embeddings, is now described.

It is assumed that word embeddings, as described above, are available for all words in the training data 46.

Let a∈ [symbol] ⁿ^{₁} and b∈ [symbol] ⁿ^{₂} be two word embedding vectors. The Kronecker product of the two vectors can be denoted as a⊗b∈ [symbol] ⁿ^{₁}*ⁿ^{₂}, which results in vector that has one dimension for any two dimensions of the argument vectors. This implies that the product of the i-th coordinate of a times the j-th coordinate of b results in the (i−1)*n₁+j coordinate of a⊗b. In the exemplary embodiment, n₁=n₂, i.e., all word embeddings have the same number of dimensions. For example, if the word embeddings are of size n=50, then the vector a⊗b has 2500 dimensions.

In the exemplary embodiment, the tensor product model 40 for PP attachment can be represented as follows:

ƒ(h,p,m)=vₕ^{T}W[vₚ⊗vₘ] (2)

for any coordinate of h,p,m, where W∈ [symbol] ^{n×n}^{²} is a matrix of parameters, taking the embedding of the attachment candidate h (on the left), and the Kronecker product of embeddings of the p-m phrase (on the right). vₕ, vₚ, and vₘ are the respective word embeddings of h,p, and m, and vₕ^{T} represents the transpose of vector vₕ. The matrix W thus has a parameter value for each combination of h,p, and m. For example, if the word embeddings are of size n=50, then the matrix W is of dimensions 50×2500. While W is referred to as a matrix, it is essentially a flattened 3D tensor. ƒ(h,p,m) is a scalar since it is computed as the inner product between vₕ^{T}W and the prepositional phrase embedding represented by vector vₚ⊗vₘ.

The scoring function can include additional terms, e.g., ƒ(h,p,m)=ƒ(vₕ^{T}W[vₚ⊗vₘ],Z), where Z represents the additional terms, which corresponds to equation (2) when there are no additional terms. These other terms may include positional information, which assigns a greater weight to candidate heads that are closer to the prepositional phrase, in a text sequence, than others.

FIG. 4 illustrates the tensor product 44 of word embeddings 72, 74, 76, etc., where h, p, and m are the head, preposition, and modifier of the PP attachment structure, represented by their word embeddings. The tensor product forms a cube, which can be unfolded, with respect to the head and the prepositional phrase, resulting in a decomposition 80 which includes the matrix W 68.

Eqn. 2 is a multi-linear function, i.e., it is a function that is non-linear on each of the three argument vectors, but is linear in their product. Thus, the model 40 exploits all conjunctions of latent features present in the word embeddings, resulting in a cubic number of parameters with respect to n. Assuming that the word embeddings are pre-processed to have an extra dimension fixed to 1, then the model has parameters for each of the word embeddings alone, all binary conjunctions between any two vectors, and all ternary conjunctions.

Equation (2) is a multi-linear tensor written as a bilinear form. That is, the tensor 44 is unfolded into a matrix W that groups vectors based on the nature of the attachment problem: the vector for the head candidate is on the left side, while the vectors for the prepositional phrase are on the right side. Without any constraints on the parameters W, this grouping is irrelevant and could be a standard linear model between a weight vector and the tensor products of all vectors: w·[vₕ⊗vₚ⊗vₘ]. However, the exemplary learning method, described with respect to Algorithm 1, below, imposes low-rank constraints on W, for which the unfolding of the tensor becomes relevant.

### Low-rank Matrix Learning (S106)

In the following, the terms “optimization,” “minimization,” and similar phraseology are to be broadly construed as one of ordinary skill in the art would understand these terms. For example, these terms are not to be construed as being limited to the absolute global optimum value, absolute global minimum, and so forth. For example, minimization of a function may employ an iterative minimization algorithm that terminates at a stopping criterion before an absolute minimum is reached. It is also contemplated for the optimum or minimum value to be a local optimum or local minimum value.

Learning the parameters W can include optimizing a loss function, such as optimizing the logistic loss with a low rank regularization, such as nuclear norm regularization (l*). Such an objective function favors matrices W that have low-rank. This regularized objective has been found to be effective for feature-spaces that are highly conjunctive, such as those that result from tensor products of word embeddings. The nuclear norm of a matrix is equivalent to the l₁-norm of the vector of its singular values.

In the exemplary model 40, the number of parameters is n³ (where n is the size of the individual embeddings). If W has rank k, then it can be rewritten as W=UV^{T} where U∈ [symbol] ^{n×k} and V∈ [symbol] ⁿ^{²}^{×k} are low rank matrices. Thus the score function can be rewritten as a k-dimensional inner product between the left and right vectors projected down to k dimensions:

θ(h,p,m)=[vₕ^{T}U][V^{T}[Vₚ⊗Vₘ]]

If k is low, then the score is defined in terms of a few projected features, which can benefit generalization. In particular, k may be less than the number of dimensions of the word embeddings, such as less than 100, or up to 50, or at least 10, or at least 15.

Let X be the training set 46. The convex objective to be optimized can be represented as:

_{w}^{argmin}logistic(X,W)+λ∥W∥* (3)

which combines the logistic loss function with a regularization term. In one embodiment, the regularization term is a nuclear norm regularizer ∥W∥* which is weighted by a regularization factor A (a scalar constant). A can be determined by cross-validation.

The logistic loss function logistic(X,W) is a measure of how well W performs on the training set. The goal is for W to predict a value of 1 (correct) for all tuples with a correct head for the prepositional phase and 0 (incorrect) for all others. The nuclear norm regularization term biases the matrix to being of low rank.

To find the optimum set of weights W, an optimization method based on Forward-Backward Splitting (FOBOS) can be used, as described in Duchi, et al., “Efficient online and batch learning using forward backward splitting,” J. Machine Learning Res., 10:2899-2934, 2009.

An algorithm for FOBOS using the l* regularizer ∥W∥* is shown in Algorithm 1.

Algorithm 1: FBOS Proximal Algorithm

```
Input: Gradient and initial matrix W
Constants: λ (regularization factor), T (max iterations) and η (learning
rate)
Output: Wₜ₊₁
  1. W₁ = 0
  2. while iteration t < max iteration T do
  3. W′ = Wₜ − ηₜg(Wₜ)
  4. UΣV^{T} = SVD(W′)
  5. σ̅ᵢ = max(σᵢ − ηₜλ, 0)
  6. Wₜ₊₁ = UΣ̅V^{T}
  7. end
```

In the Algorithm, Σ is a diagonal matrix produced by the singular value decomposition (SVD), where each diagonal element is a singular value represented by σᵢ; and Σ̅ is a truncated diagonal matrix, where each element is represented by σ̅ᵢ. g(Wₜ) is the gradient of W at the tth iteration.

The matrix W₁ can be initialized with all values being 0, as shown in line 1, although other initialization values could be selected, since the algorithm is convex and thus tends towards the optimal value over time. Briefly, the algorithm works by first computing the gradient of the negative log likelihood function as shown in line 3, where ηₜ is the step size (learning rate) at time t, and g(Wₜ) is the gradient at time t. This results in an intermediate matrix W′ of the same dimensions as W. As an example, the learning rate can be ηₜ=c/\sqrt{t}, where c is a constant. The learning rate thus diminishes over time. Other methods of changing the learning rate can be used.

For the proximal step, using nuclear norm regularization (l*), first Singular Value Decomposition (SVD) of the intermediate weight matrix W′ is performed (line 4). This decomposes the matrix W′ into three matrices, U,Σ,V. The SVD step is followed by iterative shrinkage and thresholding of the singular values (line 5). This truncation step sets some of the values in Σ to 0, forcing the matrix to have lower rank. The Singular Value Decomposition of W′ is thus computed at each iteration. In practice, since the dimensions of W′ can be relatively small, this allows fast SVD computations.

This algorithm has fast convergence rates, suitable for the present method. However, other optimization approaches may be employed. For example, l₂ regularization could be used in place of the nuclear norm. Then, Wₜ₊₁ is computed as

$${W}_{t + 1} = \frac{1}{1 + {η}_{t} λ} {W}^{′} , i . e . ,$$

the weights are regularized by using geometric shrinkage. By using low-rank constraints of the nuclear norm during learning of the matrix 60, improvements are observed over l₂ regularization (i.e., is the sum of the square of the weights), however, the l₂ regularization can still yield good results in practice.

Alternatively, the regularization term could be expressed as a convex constraint and a projected gradient method utilized, which has a similar convergence rate. However, proximal methods using or l* or l₂ regularization are slightly easier to implement.

In general, low-rank constraints are useful for controlling the capacity of the tensor model 40. The tensor model 40 also tends to be simpler than neural compositions, because it avoids non-linearities and can be optimized with global routines like SVD.

Parsing input text (S112)

The input text 42 is parsed to identify prepositional phrases and candidate heads. Any suitable syntactic parser can be used. As an example, a rule-based parser may be used for syntactically analyzing the input text string in which the parser applies a plurality of rules which describe syntactic properties of the language of the input text string. Such parsers are described, for example, in U.S. Pat. No. 7,058,567, issued Jun. 6, 2006, entitled NATURAL LANGUAGE PARSER, by Aït-Mokhtar, et al., and Aït-Mokhtar, et al., “Robustness beyond Shallowness: Incremental Dependency Parsing,” Special Issue of NLE Journal (2002). Similar incremental parsers are described in Aït-Mokhtar “Incremental Finite-State Parsing,” in Proc. 5th Conf. on Applied Natural Language Processing (ANLP'97), pp. 72-79 (1997), and Aït-Mokhtar, et al., “Subject and Object Dependency Extraction Using Finite-State Transducers,” in Proc. 35th Conf. of the Association for Computational Linguistics (ACL'97) Workshop on Information Extraction and the Building of Lexical Semantic Resources for NLP Applications, pp. 71-77 (1997). The parser first tokenizes the input text to generate a sequence of tokens, such as words, punctuation, and so forth. Morphological analysis is then performed to assign parts of speech to the tokens (such as noun, verb, adjective, etc.). In some embodiments, the prepositional phase is identified as consisting of a preposition and the next most closely positioned noun phrase to the preposition in the text sequence (i.e., going from left to right in the case of English). In other embodiments, the syntactic analysis may further include the construction of a set of syntactic relations (dependencies) between the words, in particular, prepositional phrases. In some embodiments, the parsed text may be represented as a dependency tree in which identified dependencies form nodes of the tree linking nodes representing their component textual elements.

The output of the parser is a set of 0, 1, or more prepositional phrases for each sentence of the input text and, for each identified prepositional phrase, a set of 1, 2, or more candidate heads, such as all identified verbs and nouns, other than the object in the prepositional phrase under consideration.

As will be appreciated, in the event that no prepositional phrase is identified, or only one possible head for a prepositional phrase is present in a sentence, then steps S114 and S116 can be omitted for that sentence.

In some embodiments, the data is preprocessed by lowercasing all tokens, mapping numbers to a special token NUM and symbols to a special token SYM. This also facilitates retrieval of word embeddings from the vocabulary 48 (S114).

### Predicting Prepositional Phrase Attachments (S116)

For each sentence of the input text, and for each identified prepositional phrase, the model 40 is used to identify the most probable head from among the candidate heads or to provide a ranking of the candidate heads in order of their prediction scores, using the scoring function 62. In particular, the scoring function 62 defined in equation (2) is computed for each candidate head, based on the word embeddings of the candidate head and prepositional phrase. In some embodiments the score for each of the set of tuples used in learning the matrix is precomputed with the model and stored, in which case, step S116 may simply include ranking the scores for the candidate heads and outputting the most-highly ranked one. However, it is to be appreciated that the model 40 is also suited to generating scores for words which are unseen in the training set 46, such as out-of-domain words.

The exemplary method for PP attachment resolution based on tensor products of the word vectors in a PP attachment decision can provide an improvement over more simple compositions (based on sum or concatenation), while it remains computationally manageable due to the compact nature of the word embeddings.

In experiments on standard PP attachment datasets, the tensor product-based model 40 performs better than other methods that use lexical information only, and is close in performance to methods using richer feature spaces. The accuracies obtain are particularly good in out-of-domain tests. Since the exemplary model only depends on word embeddings, this indicates that word embeddings are appropriate representations to generalize to unseen PPA structures.

In NLP, and in syntax in particular, other paradigmatic lexical attachment ambiguities exist, that, like PP attachment, can be framed within a particular scope of the dependency tree. These include adjectives, conjunctions, raising and control verbs, etc. The tensor product described herein can serve as a building block to define dependency parsing methods that make use of products of word embeddings in predicting dependencies.

Without intending to limit the scope of the exemplary embodiment, the following Examples illustrate the effectiveness of the exemplary multi-linear model for PP attachment that makes use of tensor products of word embeddings, capturing all possible conjunctions of latent embeddings.

### EXAMPLES

Experiments using the tensor models for PP attachment are performed and the accuracy of the models evaluated with respect to the type and size of word embeddings, and with respect to how these embeddings are composed. The exemplary multi-linear model for PP attachment that makes use of tensor products of word embeddings, capturing all possible conjunctions of latent embeddings. The usefulness of the method is shown by in the Examples on standard benchmarks for PP attachment.

### Data and Evaluation

Standard datasets for PP attachment are used for two settings: binary and multiple candidate attachments. In both cases, the evaluation metric is the attachment accuracy. The datasets are as follows.

### A. RRR Dataset:

This English language dataset for PP attachment is described by Ratnaparkhi 1994, and is extracted from the Penn TreeBank (PTB) corpus of sentences. The dataset contains 20,801 training samples of PP attachment tuples [symbol] v, o,p,m [symbol] . The data is preprocessed before use by lowercase all tokens, mapping numbers to a special token NUM and symbols to a special token SYM. The development set from PTB, with 4,039 samples, is used to compare various configurations of the model. For testing, several test sets proposed in the literature are employed:

1. The test set from the RRR dataset, with 3,097 samples from the PTB.

2. The New York Times test set (NYT) released by Nakashole, et al., “A knowledge-intensive model for prepositional phrase attachment,” Proc. 53rd Annual Meeting of the ACL, pp. 365-375, 2015, hereinafter Nakashole 2015. It contains 293 test samples.

3. Wikipedia test set (WIKI) released by Nakashole 2015. It contains 381 test samples from Wikipedia. Because the texts are not news articles, this is an out-of-domain test.

### B. Belinkov 2014 Datasets:

Datasets released by Belinkov 2014 for English and Arabic (available at http://groups.csail.mit.edu/rbg/code/pp) were used. These datasets follow the generalized version of PP attachment, and each sample consists of a preposition p, the next noun following the preposition m, and a list of possible attachment heads H (which contains candidate nouns and verbs in the same sentence as the prepositional phrase, e.g., all the nouns and verbs preceding it). The English dataset is extracted from the PTB corpus, and has 35,359 training samples and 1,951 test samples. The Arabic dataset is extracted from the Statistical Parsing of Morphologically Rich Languages (SPRML) shared task data, and consists of 40,121 training samples and 3,647 test samples.

### Word Embeddings

Experiments were performed with different types of word embeddings. Two word embedding methods were employed and the word embedding vectors estimated using different data sources. The configurations are as follows:

1. Skip-gram: The Skip-gram model from word2vec was used, as described above. Embeddings of different dimensionalities (n=50, 100, or 300) were induced. In all cases a window of size 5 was used during training. In preliminary experiments a window of 2 was also evaluated, which performed worse. Word embeddings were trained for each of the following data sources:
The Brown Laboratory for Linguistic Information Processing (BLLIP) corpus (Charniak, et al., “BLLIP 1987-89 WSJ Corpus Release 1, LDC No. LDC2000T43,” Linguistic Data Consortium 2000), with about 1.8 million sentences and about 43 million tokens of Wall Street Journal text (and excludes PTB evaluation sets).
English Wikipedia, with about 13.1 million sentences and about 129 million tokens. The corpus and preprocessing script were sourced from http://mattmahoney.net/dc/textdata.
The New York Times portion of the GigaWord corpus, with about 52 million sentences and about 1,253 million tokens.

2. Skip-dep: The Skip-dep model as described above was used. 50, 100 and 300 dimensional dependency-based embeddings were trained, using the BLLIP corpus in the same setting as described in Bansal 2014, but using TurboParser (http://www.cs.cmu.edu/ark/TurboParser) to obtain dependency trees for BLLIP. For Arabic, pre-trained 100-dimensional word embeddings from the arTenTen corpus were used that are distributed with the data.

A special “unknown” vector was generated for unseen words by averaging the word vectors of least frequent words (those with frequency less than 5). Further, a fixed dimension set to 1 was appended to all word vectors. Thus, while referring to vectors of dimension n, vectors of dimension n+1 are actually used.

### Experiments on the Binary Attachment Setting

A series of experiments were performed using the classic binary setting of Ratnaparkhi 1994.

### Comparing Word Embeddings

Word embeddings of different types (Skip-gram and Skip-dep) trained on different source data (BLLIP, Wikipedia, NYT), for different dimensions (50, 100, 300) were evaluated on the exemplary tensor product model of Eq. (2), that resolves the attachment using only a product of word embeddings. TABLE 1 shows the accuracy results on the RRR development set.

TABLE 1
Attachment accuracy on the RRR development set for tensor product
models using different word embeddings

| | | Accuracy wrt. | | |
|---|---|---|---|---|
| Word Embedding | | dimension (n) | | |
| Type | Source Data | n = 50 | n = 100 | n = 300 |
| Skip-gram | BLLIP | 83.23 | 83.77 | 83.84 |
| Skip-gram | Wikipedia | 83.74 | 84.25 | 84.22 |
| Skip-gram | NYT | 84.76 | 85.06 | 85.15 |
| Skip-dep | BLLIP | 85.52 | 86.33 | 85.97 |

Looking at results using Skip-gram, two clear trends are observed: results improve whenever (1) the dimensionality of the embeddings (n) is increased and (2) the size of the corpus used to induce the embeddings is increased (BLIPP is the smallest, NYT is the largest). When looking at the performance of models using Skip-dep vectors, which are induced from the smallest data but using parse trees, then the results are much better than with any version of Skip-gram. This indicates that syntactic-based word embeddings favor PP attachment. The peak performance is for Skip-dep using 100 dimensional vectors.

### Comparing Compositions

Other methods for composing word embeddings are compared with the exemplary tensor product. These methods compose the prepositional phrase (i.e., the preposition and modifier vectors) in different ways.

The models compared are as follows:

1. Sum: Instead of using the product of embeddings, the sum (vₚ+vₘ), is considered, i.e.:

ƒ(h,p,m)=vₕ^{T}W(vₚ+vₘ) (4)

2. Concatenation: Instead of using the product of embeddings, the concatenation [vₚ;vₘ], is considered, i.e.:

ƒ(h,p,m)=hd h^{T}W[vₚ;vₘ] (5)

These first two models drastically reduce the expressivity and dimension of the vector representing the prepositional phrase, from n² for the product to n for the sum, or 2n for the concatenation.

3. Preposition Identities (p indicator): The exemplary tensor model is defined essentially over word embeddings, and ignores the actual identity of the words on either side. However, for PP attachment, it is common to have parameters for each preposition, and this can be incorporated in the model. Let [symbol] be the set of prepositions, and let iₚ∈ [symbol] ^{|P|} be an indicator vector for preposition p. The prepositional phrase embedding can then be represented as iₚ⊗vₘ. This model is now equivalent to writing:

ƒ(h,p,m)=vₕ^{T}Wₚvₘ (6)

where there is a separate parameter matrix Wₚ∈ [symbol] ^{n×n} per preposition p. For further details on this approach, see Madhyastha, et al., “Learning task-specific bilexical embeddings,” Proc. COLING 2014, 25th Intl Conf. on Computational Linguistics: Technical Papers, pp. 161-171, 2014.

4. Positional Information: Positional information often improves syntactic models. Following Belinkov 2014, H is considered to be ordered with respect to the distance of each candidate to the preposition. Let δₕ be the position of element h (thus δₕ is 1 if h is the closest candidate to p, 2 if it is the 2nd closest, . . . ). In vector form, let δₕ∈ [symbol] ^{|H|} be a positional indicator vector for h (i.e., the coordinate δₕ is 1). The word embedding of h can now be composed with positional information as δₕ⊗vₕ, which is equivalent to:

ƒ(h,p,m)=vₕ^{T}W_{δ}_{ₕ}vₚ⊗vₘ (7)

Models 1-3 are compared empirically with the tensor product, using Skip-dep vectors with n=50 as word embeddings. TABLE 2 summarizes the accuracy results on the development set. The table also shows the size of the resulting tensor (note that | [symbol] | is 66 for the RRR data, thus using a 50-dimensional embedding for p results in a more compact tensor than using p's identity).

TABLE 2
Development accuracy for several ways of composing the word
embeddings of the prepositional phrase

| | | |
|---|---|---|
| Composition of p and m | Tensor Size | Acc. |

| | | | |
|---|---|---|---|
| Sum | [vₚ + vₘ] | n × n | 84.42 |
| Concatenation | [vₚ; vₘ] | n × 2n | 84.94 |
| p Indicator | [iₚ ⊗ₘ] | n × \|P\| * n | 84.36 |
| Product | [vₚ ⊗ vₘ] | n × n * n | 85.52 |

In TABLE 2, iₚ∈^{|} [symbol] ^{|} denotes an indicator vector for preposition p, where [symbol] is the set of prepositions

The results clearly show that the tensor product model provides the highest accuracy, despite the fact that the number of parameters is cubic in the dimension of the word embeddings. The same trend was also observed for larger vectors.

### Comparison to Other Attachment Methods

Results on the test sets for the binary setting for the tensor product model running with three different word embeddings are compared to published results for existing methods:

1. Back-off model of Collins, et al., “Prepositional phrase attachment through a backed-off model,” Natural Language Processing Using Very Large Corpora, pp. 177-189,1999.

2. Neural model of Belinkov 2014, which composes word embeddings in a neural fashion.

These two systems use no other information that the lexical items (i.e., explicit words or word embeddings).

3. Model of Stetina 1997.

4. Model of Nakashole 2015.

These latter two systems use additional features, in particular, semantic information from WordNet or other ontologies, which has been shown to be beneficial for PP attachment. The results are shown in TABLE 3.

TABLE 3
Accuracy results over the RRR, NYT and WIKI test sets. (*) indicates
that the system uses additional semantic features

| | Test Accuracy | | |
|---|---|---|---|
| System | RRR | WIKI | NYT |
| Tensor product (Skip-dep, BLIPP, n = 100) | 86.13 | 83.60 | 82.30 |
| Tensor product (Skip-gram, Wikipedia, n = 100) | 84.96 | 83.48 | 82.13 |
| Tensor product (Skip-gram, NYT, n = 100) | 85.11 | 83.52 | 82.65 |
| Stetina 1997 | 88.1 | — | — |
| Collins 1999 | 84.1 | 72.7 | 80.9 |
| Belinkov 2014 | 85.6 | — | — |
| Nakashole 2015 | 84.3 | 79.3 | 84.3 |

In general, the results obtained by the exemplary tensor product model (first three rows) are remarkably good, despite the fact that additional information is not used. On the RRR test, with the exception of the result by the Stetina 1997 (which requires additional information), the tensor product method using Skip-dep embeddings clearly outperforms the other systems. On the WIKI test, the tensor product model is clearly the best, while on the NYT test, the tensor product model is not quite as good as Nakashole 2015, but has advantages in that it does not need additional information.

### Experiments on the Multiple Attachment Setting

The performance of the tensor product model on the setting and data of Belinkov 2014, which deals with multiple head candidates was evaluated. Experiments on both English and Arabic datasets were performed. For this setting, following Belinkov 2014, positional information of the head candidate, as described by Eq. 7 was employed. Without it the performance was much worse (possibly because in this data, a large number of samples attach to the first or second candidate in the list—about 93% of cases on the English data).

For English, tensor product models trained with the nuclear-norm (l*) and l₂ regularization, using 50-dimensional embeddings, were used. Imposing low-rank on the product tensor yields some gains with respect to l₂, however the improvements are relatively small. This is probably because embeddings are already compressed representations, and even products of them do not result in overfitting to the training data. One characteristic of low-rank regularization is the inherent compression of the tensor.

The tensor product method was compared to a set of models by Belinkov 2014. The Belinkov “basic” model uses Skip-gram. The Belinkov “syn” model uses syntactic vectors. The Belinkov “feat” model uses features from WordNet and VerbNet. The Belinkov “full” model is a combination of the other four models. Yu, et al., “Embedding lexical features via low-rank tensors,” Proc. 2016 Conf. of the North American Chapter of the Assoc. for Computational Linguistics: Human Language Technologies, pp. 1019-1029, 2016 (Yu 2016) describes a tensor model that combines standard feature templates (again using WordNet) with word embeddings. TABLE 4 shows the results.

TABLE 4
Test accuracy for PP attachment with multiple head candidates

Test Accuracy

| System | Arabic | English |
|---|---|---|
| Tensor product (n = 50, l_{*}) | — | 88.3 |
| Tensor product (n = 50, l₂) | — | 87.8 |
| Tensor product (n = 100, l_{*}) | 81.1 | 88.4 |
| Belinkov (basic) | 77.1 | 85.4 |
| Belinkov (syn) | 79.1 | 87.1 |
| Belinkov (feat) | 80.4 | 87.7 |
| Belinkov (full) | 82.6 | 88.7 |
| Yu 2016 | — | 90.3 |

The tensor product model performs favorably to other models, except for Belinkov (full) and Yu 2016, which use additional features.

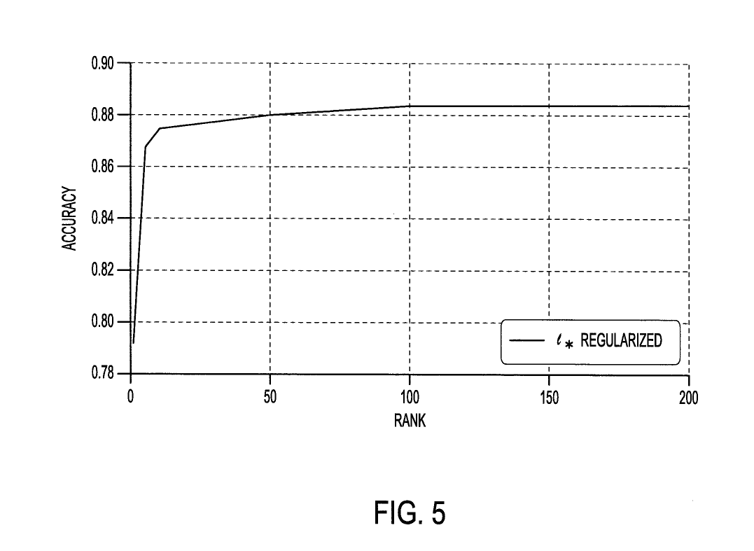

FIG. 5 is a plot showing accuracy versus rank of the tensor model on the English data of Belinkov 2014. The tensor model uses 50-dimensional vectors composed with head position, and has size 357×2,500. The word embeddings are 50 (+1)-dimensional embeddings composed with positional information (considering 7 head positions). Thus, the unfolded matrix W has 357 rows and 2,601 columns. With rank 50 the model obtains 88% accuracy. A slight gain is observed by using 100-dimensional embeddings.

The results described herein suggest that a solution based on tensor products of word embeddings improves over other approaches for composing embeddings, such as averaging or concatenation. The exemplary multi-linear model can outperform non-linear models that exploit the same information. Furthermore, its performance is close to that of models that use additional knowledge sources for semantic information such as WordNet and VerbNet. This seems to suggest that products of word embeddings should be the core feature space of choice to resolve lexical attachment ambiguities, especially for target domains (e.g., healthcare) for which the terminology does not have entries in WordNet. The present model achieves a significant improvement on an out-of-domain test set over the best reported performance for that setting.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for resolving prepositional phrase attachments, comprising:
for an input sequence of text, identifying a prepositional phrase and a set of candidate heads for the prepositional phrase, the prepositional phrase comprising a preposition and a modifier;
with a processor, for each candidate head in the set of candidate heads, scoring the candidate head with a scoring function which outputs a score as a function of a tensor product of:
a) a word embedding of the candidate head,
b) a product of word embeddings of the preposition and modifier of the preposition, and
c) a matrix of learned parameters or a decomposition thereof; and
identifying one of the candidate heads as a predicted head for attachment to the prepositional phrase based on the scores for the candidate heads.

2. The method of claim 1, further comprising retrieving the word embeddings for the preposition, modifier of the preposition, and word embeddings of the candidate heads from a vocabulary of word embeddings.

3. The method of claim 1, wherein the word embeddings of the preposition, modifier of the preposition, and candidate heads are multidimensional vectors of at least 20 dimensions.

4. The method of claim 1, wherein the word embeddings of the preposition, modifier of the preposition, and candidate heads are generated with a model which, for a given word, considers a context of surrounding words for occurrences of the given word in a corpus of training sentences.

5. The method of claim 4, wherein the word embeddings are selected from word2vec and skip-dep word embeddings.

6. The method of claim 1, wherein the matrix is of size n×n², where is n the dimensionality of the word embeddings.

7. The method of claim 1, wherein the scoring function is of the form:
ƒ=(vₕ^{T}W[vₚ⊗vₘ]), or a function thereof,
wherein W represents the matrix of parameters or decomposition thereof,
vₕ, vₚ, and vₘ are the word embeddings of the candidate head, preposition, and modifier, respectively, and vₚ⊗vₘ represents an outer product of vₚ and vₘ.

8. The method of claim 7, wherein the outer product of vₚ and vₘ is the Kronecker product.

9. The method of claim 1, further comprising outputting the predicted head as an attachment to the prepositional phrase.

10. The method of claim 1, wherein the identifying of the set of candidate heads for the prepositional phrase, comprises identifying verbs and nouns in the sequence of text.

11. The method of claim 1, wherein the identifying of the set of candidate heads for the prepositional phrase, comprises identifying all verbs and all nouns which precede the prepositional phrase in the sequence of text as candidate heads.

12. The method of claim 1, further comprising learning the matrix of learned parameters.

13. The method of claim 12, wherein the learning comprises optimizing a loss function over a training set of tuples, each tuple consisting of a head, a preposition, and a modifier of the preposition.

14. The method of claim 13, wherein the loss function combines a logistic loss with a regularization term selected from a nuclear norm regularization term and an l₂ regularization term.

15. The method of claim 13, wherein the loss function is of the form:
_{W}^{argmin}logistic(X,W)+λ∥W∥* (3)
where logistic(X,W) represents the logistic loss over the training set X, ∥W∥* represents the nuclear norm of the matrix W, and λ represents a regularization factor.

16. The method of claim 13, wherein the loss function is learned by an iterative gradient method which iteratively updates a prior matrix to generate a current matrix.

17. The method of claim 1, wherein the matrix of learned parameters is decomposed as two low rank matrices of rank k where k is less than the number of dimensions of the word embeddings.

18. A computer program product comprising a non-transitory recording medium storing instructions, which when executed on a computer, cause the computer to perform the method of claim 1.

19. A system comprising memory which stores instructions for performing the method of claim 1, and a processor in communication with the memory for executing the instructions.

20. A system for resolving prepositional phrase attachments, comprising:
memory which stores a matrix of learned parameters or a decomposition thereof into lower-rank matrices;
a parser which, for an input sequence of text, identifies a prepositional phrase and a set of candidate heads for the prepositional phrase, the prepositional phrase comprising a preposition and a modifier;
an embedding component which identifies embeddings for the candidate heads, the preposition and the modifier;
a prediction component which identifies one of the candidate heads for attachment to the prepositional phrase, the prediction component using a scoring function which, for each candidate head in the set of candidate heads, outputs a score as a function of a tensor product of:
a) a word embedding of the candidate head,
b) a product of word embeddings of the preposition and modifier of the preposition, and
c) a matrix of learned parameters;
an output component which outputs the identified one of the candidate heads or information based thereon; and
a processor which implements the parser, embedding component, prediction component and output component.

21. A method for resolving prepositional phrase attachments, comprising:
receiving a training set of tuples, each tuple consisting of a preposition, a modifier of the preposition, a list of candidate heads, and a pointer to one of the candidate heads that is a correct one;
providing a word embedding for each of the candidate heads, prepositions, and modifiers in the training set;
learning a matrix of learned parameters using the word embeddings of the tuples;
providing a parser which is configured for identifying a prepositional phrase and a set of candidate heads for the prepositional phrase for an input sequence of text, the prepositional phrase comprising a preposition and a modifier;
providing a prediction component configured to identify one of the candidate heads for attachment to the prepositional phrase using a scoring function which, for each candidate head in the set of candidate heads, outputs a score as a function of a tensor product of:
a) a word embedding of the candidate head,
b) a product of word embeddings of the preposition and modifier of the preposition, and
c) the matrix of learned parameters.
